(19) United States
(12) Patent Application Publication
(10) Pub. No.: US 2026/0114660 A1
(43) Pub. Date: Apr. 30, 2026

(54) ELECTRONIC SCALE AND COFFEE MACHINE

(71) Applicant: Ramsey James Gyde, HONG KONG (CN)

(72) Inventor: Ramsey James Gyde, HONG KONG (CN)

(21) Appl. No.: 19/031,157

(22) Filed: Jan. 17, 2025

(30) Foreign Application Priority Data
Oct. 25, 2024 (CN) 202422594111.1

(51) Int. Cl. A47J 31/44; G01G 19/52; G01G 23/37

(52) U.S. Cl. CPC A47J 31/44; G01G 19/52; G01G 23/3721

(57) ABSTRACT

The disclosure discloses an electronic scale and coffee machine, the coffee machine includes a scale body and a touch all-screen display, the scale body has a carrier platform and an interior space, the touch all-screen display covers on the carrier platform, the interior space is provided with a load unit, which is connected to the touch all-screen display, and is used to detect the weight change on the touch all-screen display, which displays weight in real time according to the weight changes. In the technical solution of this disclosure, the touch all-screen display completely covers the carrier platform, using the touch all-screen display for weighing, so that the weighing area and the display area are integrated into one, and accurate weighing and a fully interactive and customizable user interface are combined, the universality and accuracy of the electronic scale are greatly increased, and the appearance is fashionable and beautiful.

### CROSS REFERENCE TO RELATED APPLICATIONS

The present application claims the benefit of Chinese Patent Application No. 2024225941111 filed on Oct. 25, 2024, the contents of which are incorporated herein by reference in their entirety.

### TECHNICAL FIELD

The disclosure relates to the field of electronic scales, and in particular to an electronic scale and a coffee machine with an all-screen display.

### BACKGROUND

Electronic scale is one of the common weighing instruments in daily life, mainly used for weighing the mass of items. Compared with traditional scale, electronic scale has higher measurement accuracy. High-accuracy electronic scale can provide more accurate measurement results, which is beneficial for ensuring measurement accuracy.

Existing electronic scales usually adopt a design in which the weighing area and the operation display area are separated, that is, a part of the scale surface is only used for weighing, another part is only used for user operation and display, and the weighing area is usually much larger than the operation display area. This makes the function of the electronic scale has some limitations, and in the usage scenario where more information needs to be displayed, the operation display area cannot have one-stop display of all the information, in addition, in the usage scenario where an object with a large quantity or a large area needs to be weighed, in order to adapt to a larger weighing area, the electronic scale needs to be made with a very large volume, which is inconvenient for users to carry and use at any time and any place.

In addition, the existing electronic scale designs are dull, not fashionable or beautiful enough, and cannot meet the user's fashion needs in some application scenarios, for example, when users use coffee machine to brew coffee by themselves, they usually want the entire set of coffee machine to uphold to the same style and fashion, the existing electronic scale designs obviously cannot meet such needs.

### CONTENT OF THE PRESENT INVENTION

One of the purposes of the present disclosure is to overcome the deficiencies in the prior art, and to provide an electronic scale and a coffee machine in response to the problem that the electronic scale adopts the design of separating the weighing area and the operation display area, which has limitations in functionality and a dull design.

In order to achieve the above objectives, the present disclosure provides the following technical solutions:

In a first aspect, the disclosure provides an electronic scale, which includes a scale body and a touch all-screen display, the scale body has a carrier platform and an interior space, the touch all-screen display covers on the carrier platform, the interior space is provided with a load unit, the load unit is connected to the touch all-screen display, the load unit is used to detect the weight change on the touch all-screen display, the touch all-screen display displays weight in real time according to the weight changes.

In a preferred embodiment of the disclosure, the touch all-screen display includes a screen body and a control module, the control module is installed on the carrier platform, the screen body is installed on the control module, the area of the screen body is not smaller than the area of the control module.

In a preferred embodiment of the disclosure, the carrier platform includes a carrier plate and a supporting platform, the supporting platform is located around the carrier plate, the carrier plate recesses toward the interior space with respect to the supporting platform, the edge of the screen body protrudes from the edge of the control module and is supported on the supporting platform.

In a preferred embodiment of the disclosure, the interior space is provided with a control circuit board, the carrier plate is provided with a first connection hole, the control module is provided with a flexible circuit board, the control module is connected to the control circuit board via the flexible circuit board passing through the first connecting hole.

In a preferred embodiment of the disclosure, the first connection hole is provided on the edge of one side of the carrier platform, the supporting platform is provided correspondingly with an escape groove, the flexible circuit board protrudes from the side surface of the control module, and passes through the first connecting hole via the escape groove.

In a preferred embodiment of the disclosure, the supporting platform is opened with a sealing groove, a sealing element being embedded in the sealing groove, the screen body sealed is connected to the sealing element in a sealed manner.

In a preferred embodiment of the disclosure, the carrier platform is recessed from the edge of the scale body toward the interior space, so as to form a blocking wall at the edge of the scale body, the screen body being positioned by being clamped via the blocking wall.

In a preferred embodiment of the disclosure, the control module is equipped with a position sensor and/or a photosensitive sensor, the screen body displays non-weight information of objects according to parameters detected by the position sensor and/or the photosensitive sensor.

In a preferred embodiment of the disclosure, the load unit is fixedly installed at an inner surface facing the interior space of the carrier platform.

In a preferred embodiment of the disclosure, the scale body includes a housing and a substrate, the housing and the substrate connect to each other and enclose to form the interior space, the carrier platform is disposed on the housing and is opposite to the substrate, an outer surface of the substrate is provided with at least one waist-shaped hole, the waist-shaped hole is provided with a non-slip pad.

In a second aspect, the disclosure provides a coffee machine, including the electronic scale as described in the first aspect.

The electronic scale and coffee machine disclosed by the disclosure, make the touch all-screen display completely cover the carrier platform, use the touch all-screen display for weighing, so that the weighing area and the display area are integrated into one, and accurate weighing and a fully interactive and customizable user interface are combined, the universality and accuracy of the electronic scale are greatly increased, and the appearance is fashionable and beautiful.

### BRIEF DESCRIPTION OF THE DRAWINGS

The disclosure is described with the aid of the following drawings:

FIG. 1 is a perspective view of an electronic scale according to an example of the present disclosure;

FIG. 2 is an exploded view of the electronic scale according to an example of the present disclosure;

FIG. 3 is an A-A cross-sectional view of the electronic scale according to an example of the present disclosure;

FIG. 4 is a schematic structural diagram of the housing of the electronic scale according to an example of the present disclosure;

FIG. 5 is a schematic structural diagram of the substrate of the electronic scale according to an example of the present disclosure.

Reference numbers of the drawings:
1000 scale body; 2000 touch all-screen display;
1100 housing; 1110 carrier platform; 1111 carrier plate; 1112 supporting platform; 1113 sealing groove; 1114 first connecting hole; 1115 escape groove; 1120 side plate; 1121 end wall; 1122 side wall; 1123 blocking wall; 1200 substrate; 1201 through hole; 1202 cover plate; 1203 waist-shaped hole; 1204 non-slip pad; 1300 interior space; 1400 load unit; 1500 operating switch; 1600 power interface; 1700 control circuit board; 1800 battery module;
2100 screen body; 2200 control module; 2300 flexible circuit board.

### DETAILED DESCRIPTION OF THE PREFERRED EMBODIMENT

In order to better understand the technical solution of the present application, the examples of the present application will be described in detail below with reference to the drawings.

It should be clear that the described examples are only a part of the examples of the present application, rather than all of the examples. Based on the examples in this application, all the other examples obtained by those of ordinary skilled in the art without creative efforts fall within the scope of protection of this application.

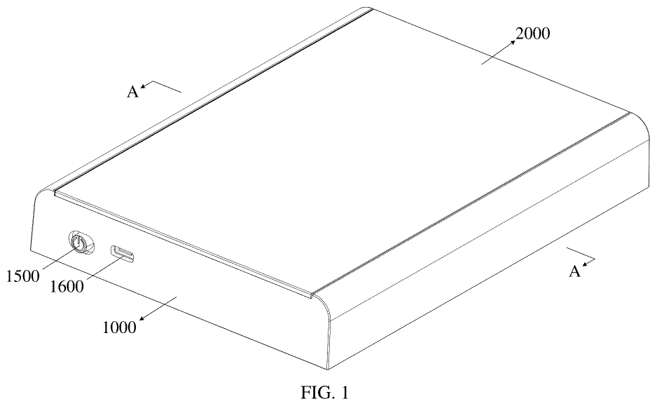

As shown in FIGS. 1 to 3, this example discloses an electronic scale, which includes a scale body 1000 and a touch all-screen display 2000, the scale body 1000 has a carrier platform 1110 and an interior space 1300, the touch all-screen display 2000 is provided on the carrier platform 1110 as an overlay, the interior space 1300 is provided with a load unit 1400, the load unit 1400 is connected to the touch all-screen display 2000, the load unit 1400 is used to detect the weight change on the touch all-screen display 2000, and the touch all-screen display 2000 displays weight in real time according to the weight change.

Specifically, the scale body 1000 can adopt a common electronic scale main body. The touch all-screen display 2000 adopts a display device that can realize multi-touch and full-screen display functions, allowing users to set environmental parameters for weighing objects with the electronic scale by operating the graphic user interface (GUI) on the touch all-screen display 2000, to achieve a customized weighing experience. In a preferred embodiment of this example, the user can also be allowed to customize the graphical user interface on the touch all-screen display 2000 according to the actual usage scenario, for example, in the coffee brewing usage scenario, make the touch all-screen display 2000 display the maximum weighing (2 kg) and the corresponding brewing time, so that when the user weighs the ground coffee powder, it can suggest the best brewing time for the user to obtain a ultimate coffee brewing experience. The carrier platform 1110 in the scale body 1000 refers to the platform on which objects are placed when using an electronic scale to weigh objects, the carrier platform 1110 can be a horizontal surface or a curved surface, but it must be a horizontally set platform, and the touch all-screen display 2000 completely covers the platform of the carrier platform 1110, and can even be set larger than the platform. The scale body 1000 is a closed integrated structure, and except for the operating switch 1500 and the power interface 1600, all components are integrated in the interior space 1300. The load unit 1400 in the interior space 1300 integrates multiple elements such as weight sensors, signal transceivers, and signal processors, of which the function is that when the weighing parameters of the touch all-screen display 2000 are set up and the object weighing work is started, the load unit 1400 collects the weight changes of the touch all-screen display 2000 via weight sensors, then processes the weight changes via signal processors, then send them to the touch all-screen display 2000 via signal transceiver, finally the touch all-screen display 2000 displays the weight of the weighing object (such as coffee powder, flour, cheese cube, etc.).

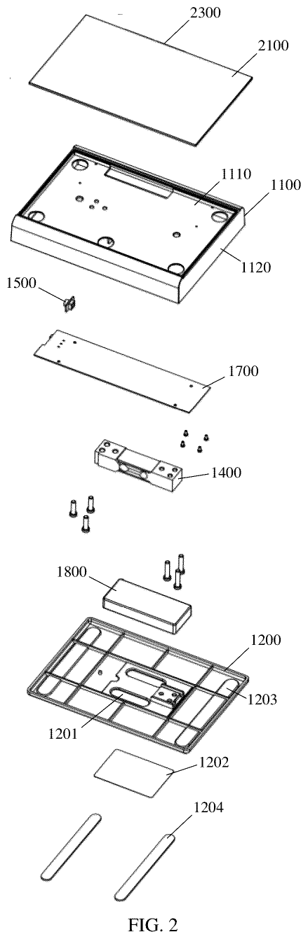

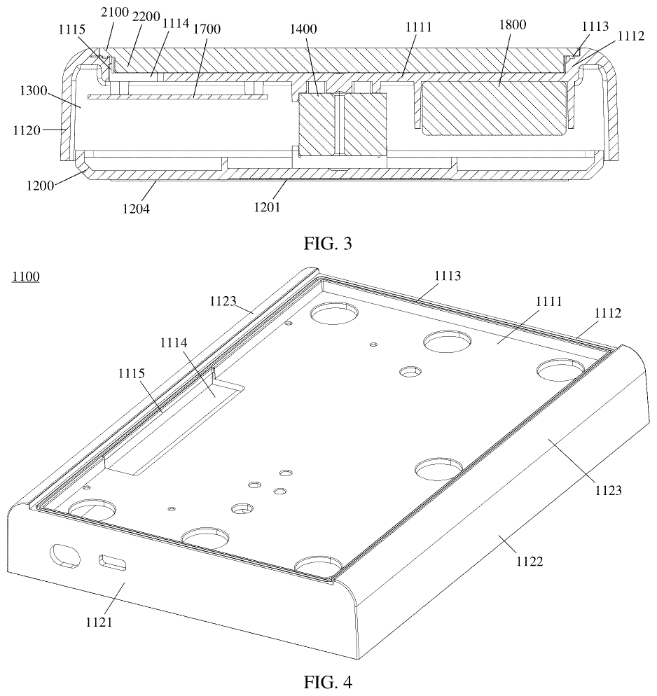

As shown in FIGS. 2 and 3, in the electronic scale of this example, the scale body 1000 includes a housing 1100 and a substrate 1200, the housing 1100 and the substrate 1200 are connected to each other and enclosed to form an interior space 1300, the carrier platform 1110 is provided on the housing 1100 and opposite to the substrate 1200. Specifically, the carrier platform 1110 and the substrate 1200 are set apart substantially in parallel, and there is a side plate 1120 between the carrier platform 1110 and the substrate 1200. The side plate 1120 can be integrally formed with the carrier platform 1110, or be integrally formed with the substrate 1200, in this example the side plate 1120 and the carrier platform 1110 are integrally formed to form the housing 1100 as an example for illustration. The upper and lower ends of the side plate 1120 surround the carrier platform 1110 and the substrate 1200, when the carrier platform 1110 is circular, the side plate 1120 is a ring-wall structure, when the carrier platform 1110 is square, the side plate 1120 consists of two opposite spaced-apart end walls 1121 and side walls 1122.

Meanwhile, the touch all-screen display 2000 includes a screen body 2100 and a control module 2200, the control module 2200 is installed on the carrier platform 1110, the screen body 2100 is installed on the control module 2200, the area of the screen body 2100 is not smaller than the area of the control module 2200. That is to say, as seen in a cross-sectional view, the touch all-screen display 2000 appears in a “T” shape, as shown in FIG. 3. Specifically, the screen body 2100 can adopt an all-screen OLED (Organic Light-Emitting Diode) display, displaying graphics or text according to the control of the control module 2200. The control module 2200 integrates multiple sensors and electronic elements, in a preferred embodiment of this example, the control module 2200 is equipped with a position sensor for real-time detection of the position of the objects placed on the touch all-screen display 2000, based on the dynamic response of the position, accurate measurement is achieved. In a preferred embodiment of this example, the control module 2200 is equipped with a photosensitive sensor for real-time analysis of the light emitted by objects placed on the touch all-screen display 2000, detecting attributes such as color, and the functions such as product quality analysis and analysis of product composition can be realized at the same time as weighing. In a preferred embodiment of this example, the control module 2200 is equipped with the above position sensor and photosensitive sensor at the same time. The screen body 2100 displays non-weight information of the object based on parameters detected by the position sensor and/or photosensitive sensor, the non-weight information includes but is not limited to temperature, humidity, composition, quality, shape, size, etc. Of course, in addition to the display component and the above position sensors and photosensitive sensors, the control module 2200 can also be equipped with other sensors or electronic elements, such as temperature sensors, pressure sensors, miniature cameras, etc.

As shown in FIG. 4, in the electronic scale of this examples, the carrier platform 1110 is square, the side plates 1120 connecting the loading platform 1110 are two end walls 1121 and two side walls 1122, which are spaced apart and surround the carrier platform 1110. The carrier platform 1110 includes a carrier plate 1111 and a supporting platform 1112, the supporting platform 1112 is located around the carrier plate 1111 and is connected to the respective upper ends of the two end walls 1121 and the two side walls 1122, the carrier plate 1111 recesses toward the interior space 1300 with respect to the supporting platform 1112, that is, the height of the carrier plate 1111 in the vertical direction is lower than the supporting platform 1112, the control module 2200 extends into the recess, fixedly installed on the carrier plate 1111 and is surrounded by the supporting platform 1112, the edge of the screen body 2100 protrudes from the edge of the control module 2200 is supported on the supporting platform 1112. The entire carrier platform 1110 is recessed from the upper ends of the two end walls 1121 and the two side walls 1122 on the edge of the scale body 1000 toward the interior space 1300, that is, in the vertical direction, the upper ends of the end walls 1121 and the side walls 1122 has the highest height and the height of the supporting platform 1112 is the next highest, and the height of the carrier plate 1111 is relatively the lowest, thereby forming a blocking wall 1123 at the edge of the scale body 1000, the blocking wall 1123 can be located at the upper ends of the two end walls 1121, or can be located at the upper ends of the two side walls 1122, since in this example the length of the side walls 1122 is much longer than that of the end walls 1121, in order to better fix the screen body 2100, the blocking walls 1123 are provided at the upper ends of the two side walls 1122, and the screen body 2100 is positioned by being clamped via the blocking walls 1123, the surface of the blocking wall 1123 that contacts the screen body 2100 is flat or has a shape that is adapted to the side surface of the screen body 2100, the cross-sectional shape of the blocking wall 1123 is fan-shaped, making the appearance of the scale body 1000 more beautiful and fashionable. The supporting platform 1112 is provided with a sealing groove 1113, the sealing groove 1113 is circular, a sealing element is embedded in the sealing groove 1113, the screen body 2100 is connected to the sealing element in a sealed manner, which can increase the connection strength between the touch all-screen display 2000 and the housing 1100, and can also prevent external foreign matters (especially powder) from entering the interior space 1300 of the scale body 1000. The interior space 1300 of the scale body 1000 is provided with a control circuit board 1700, the carrier plate 1111 is provided with a first connection hole 1114, the control module 2200 is provided with a flexible circuit board 2300, the control module 2200 is connected to the control circuit board 1700 via the flexible circuit board 2300 passing through the first connecting hole 1114, thereby realizing electrical connection between the touch all-screen display 2000 located outside the housing 1100 and the electronic elements located in the interior space 1300. The first connection hole 1114 is opened on one edge of the carrier platform 1110, the supporting platform 1112 is provided correspondingly with an escape groove 1115, the flexible circuit board 2300 protrudes from the side surface of the control module 2200, and passes through the first connecting hole 1114 via the escape groove 1115, to ensure that the wiring in the interior space 1300 does not affect detection of weight changes of objects on the touch all-screen display 2000 with the load unit 1400. The load unit 1400 is fixedly installed on an inner surface facing the interior space 1300 of the carrier platform 1110, so that the distance between the load unit 1400 and the touch all-screen display 2000 is shorter, and the weight change of the object on the touch all-screen display 2000 can be more accurately detected. In addition, the interior space 1300 is also provided with a battery module 1800, the battery module 1800 is fixedly installed on the carrier plate 1111, and can adopt lithium batteries, the battery module 1800 is used to supply power for all electronic elements in the interior space 1300 and the control module 2200 of the touch all-screen display 2000. An operating switch 1500 and a power interface 1600 are also provided on the side wall 1122 of the housing 1100, the operating switch 1500 and the power interface 1600 are connected to the control circuit board 1700, the electronic scale can be turned on or off through the operating switch 1500, and the battery module 1800 can be charged via the power interface 1600.

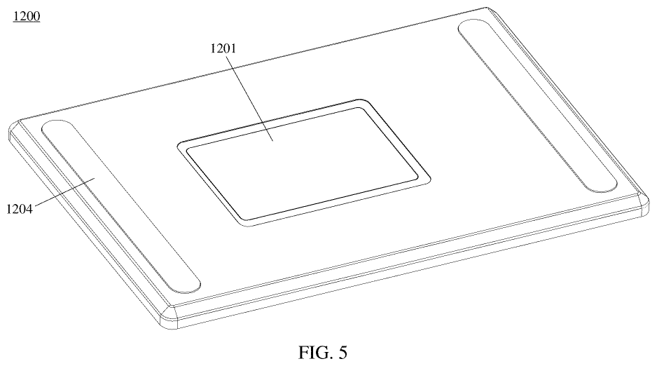

As shown in FIG. 5, in the electronic scale of this example, the substrate 1200 is square and covers up the bottom of the housing 1100 to close it. The substrate 1200 is provided with a through hole 1201 at a position corresponding to the load unit 1400, the load unit 1400 can be extended into the interior space 1300 via the through hole 1201, installed and fixed with the carrier plate 1111. The load unit 1400 can also be fixed to the substrate 1200, and the load unit 1400 can be positioned in the up-down direction by the carrier plate 1111 and the substrate 1200 to prevent the slight displacement of the load unit 1400, which will affect the accuracy of weighing during the working progress of the electronic scale. A cover plate 1202 is equipped at the through hole 1201 of the substrate 1200, and the through hole 1201 is covered by the cover plate 1202, which not only ensures the integrity of the scale body 1000, but also facilitates disassembly at any time to maintain the electronic elements in the interior space 1300. An outer surface of the substrate 1200 is provided with at least one waist-shaped hole 1203, which is provided with a non-slip pad 1204 therein. The number of waist-shaped holes 1203 is generally set to an even number, such as two or four, in a preferred embodiment of this example, the number of waist-shaped holes 1203 is two, which are respectively provided close to the two end walls 1121 and extend along the end walls 1121. The non-slip pad 1204 is made of silica gel, and the surface can be frosted to enhance friction force, to ensure the stability of the electronic scale during working.

This example also discloses a coffee machine, including the electronic scale described in the above example.

The electronic scale and coffee machine disclosed by the disclosure integrate a full-screen OLED display screen in the electronic scale, and the touch all-screen display 2000 completely covers the carrier platform 1110, the touch all-screen display 2000 is used for weighing, so that the weighing area and the display area are integrated into one, so that the electronic scale can be used as a weighing platform and also as a user interface (UI) for users to interact. It has two advantages of accurate weighing and a fully interactive and customizable user interface, and well combines the high-accuracy weighing function with high degree-of-freedom user customization, providing a unique and powerful weighing instruments for different usage scenarios such as cafe, restaurant, home, hotel, etc., greatly increasing the universality and accuracy of the electronic scale, and the appearance is fashionable and beautiful.

It should be understood that the above description of specific examples of the present disclosure is only to illustrate the technical route and characteristics of the present disclosure, and its purpose is to enable those skilled in the art to understand the contents of the present disclosure and implement it accordingly. However, the present invention is not limited to the above specific embodiments. Any changes or modifications made within the scope of the claims of the present disclosure shall be included in the protection scope of the present disclosure.

What is claimed is:

1. An electronic scale, wherein the electronic scale includes a scale body and a touch all-screen display, the scale body having a carrier platform and an interior space, the touch all-screen display covering the carrier platform, the interior space being provided with a load unit, the load unit being connected to the touch all-screen display, the load unit being used to detect the weight change on the touch all-screen display, the touch all-screen display displaying weight in real time according to the weight changes.

2. The electronic scale of claim 1, wherein the touch all-screen display includes a screen body and a control module, the control module being installed on the carrier platform, the screen body being installed on the control module, the area of the screen body being not smaller than the area of the control module.

3. The electronic scale of claim 2, wherein the carrier platform includes a carrier plate and a supporting platform, the supporting platform being located around the carrier plate, the carrier plate recessing toward the interior space with respect to the supporting platform, the edge of the screen body protruding from the edge of the control module and is supported on the supporting platform.

4. The electronic scale of claim 3, wherein the interior space is provided with a control circuit board, the carrier plate being provided with a first connection hole, the control module being provided with a flexible circuit board, the control module being connected to the control circuit board via the flexible circuit board passing through the first connecting hole.

5. The electronic scale of claim 4, wherein the first connection hole is provided on the edge of one side of the carrier platform, the supporting platform being provided correspondingly with an escape groove, the flexible circuit board protruding from the side surface of the control module, and passing through the first connecting hole via the escape groove.

6. The electronic scale of claim 3, wherein the supporting platform is provided with a sealing groove, a sealing element being embedded in the sealing groove, the screen body being connected to the sealing element in a sealed manner.

7. The electronic scale of claim 2, wherein the carrier platform is recessed from the edge of the scale body toward the interior space, so as to form a blocking wall at the edge of the scale body, the screen body being positioned by being clamped via the blocking wall.

8. The electronic scale of claim 2, wherein the load unit is fixedly installed at an inner surface facing the interior space of the carrier platform.

9. The electronic scale of claim 2, wherein the control module is equipped with a position sensor and/or a photosensitive sensor, the screen body displaying non-weight information of objects according to parameters detected by the position sensor and/or the photosensitive sensor.

10. The electronic scale of claim 1, wherein the scale body includes a housing and a substrate, the housing and the substrate connect to each other and enclose to form the interior space, the carrier platform being disposed on the housing and being opposite to the substrate, an outer surface of the substrate being provided with at least one waist-shaped hole, the waist-shaped hole being provided with a non-slip pad therein.

11. A coffee machine, wherein the coffee machine includes the electronic scale according to claim 1.

12. A coffee machine, wherein the coffee machine includes the electronic scale according to claim 2.

13. A coffee machine, wherein the coffee machine includes the electronic scale according to claim 3.

14. A coffee machine, wherein the coffee machine includes the electronic scale according to claim 4.

15. A coffee machine, wherein the coffee machine includes the electronic scale according to claim 5.

16. A coffee machine, wherein the coffee machine includes the electronic scale according to claim 6.

17. A coffee machine, wherein the coffee machine includes the electronic scale according to claim 7.

18. A coffee machine, wherein the coffee machine includes the electronic scale according to claim 8.

19. A coffee machine, wherein the coffee machine includes the electronic scale according to claim 9.

20. A coffee machine, wherein the coffee machine includes the electronic scale according to claim 10.
